(19) United States
(12) Patent Application Publication
(10) Pub. No.: US 2024/0248468 A1
(43) Pub. Date: Jul. 25, 2024

(54) PREDICTIVE MAINTENANCE FOR INDUSTRIAL MACHINES

(71) Applicant: PAUL WURTH S.A., Luxembourg (LU)

(72) Inventors: Cédric SCHOCKAERT, Wiltz (LU); Fabrice HANSEN, Doncols (LU); Christian DENGLER, Beringen (LU)

(21) Appl. No.: 18/290,384

(22) PCT Filed: Jun. 10, 2022
(86) PCT No.: PCT/EP2022/065902

§ 371 Date: Nov. 13, 2023

(30) Foreign Application Priority Data
Jun. 11, 2021 (LU) LU500272

(51) Int. Cl. G05B 23/02

(52) U.S. Cl. CPC G05B 23/0283; G05B 23/024; G05B 23/0289

(57) ABSTRACT

A computer-implemented failure predictor has a module arrangement (373) with first and second sub-ordinated modules (313, 323) that are sub-ordinated to an output module (363). The first and a second sub-oriented modules process data from an industrial machine to determine first and second intermediate status indicators. A third sub-oriented module (333) determines an operation mode indicator, and the output module (363) processes the status indicators and the operation mode indicator to predict a failure of the industrial machine. The module arrangement has been trained by cascaded training to comprises to train the sub-ordinated modules (312, 322, 332), to subsequently operate the trained sub-ordinated modules, and to subsequently train the output module.

### TECHNICAL FIELD

In general, the disclosure relates to industrial machines, and more particularly, the disclosure relates to computer systems, methods and computer-program products to predict failures of the industrial machines.

### BACKGROUND

Industrial machines that continuously operate without any interruption are as rare as perpetual motion machines.

Simplified, there are at least two main reasons for interruptions. Machine operators shut down the machines for maintenance, usually according to regular intervals. Or, the machine may stop due to a failure.

In the last decades, computer models made big progress in predicting failures. So-called predictive maintenance models allow the operators to shut down the machine for maintenance when failure is expected. Such an approach may increase the overall time the machine is operating and may decrease the time it is out of operation.

The computer models receive sensor data (and other data) from the machines and predict failure with details such as time-to-fail, type-of-failure and others. Computer models would need to know cause-and-effect relations. As in many cases, such relations are unknown, the computer is being trained with training data (usually a combination of historical sensor data and historical failure data). The training approximates the relations.

The accuracy of the prediction is important. For example, the computer may predict a failure to occur within a week, and the operator likely shuts down the machine for immediate maintenance. Incorrect predictions are critical. In a scenario of incorrect prediction, immediate maintenance was actually not required, the machine could have been operated normally without interruption.

To increase the accuracy, the skilled person faces many challenges and constraints, among them the potential lack of data (such as sensor or failure data), the potential lack of expert annotations (that identify historical failures), the potential difference between annotations from different experts, potential incorrect relevance assessment of data and so on. Further challenges will be explained below, but in general there is a requirement to increase the accuracy of any prediction.

Stich et al. describe the use of multiple computer models that classify sub-components of a wafer fab that is a complex industrial system (STICH PETER ET AL: “Yield prediction in semiconductor manufacturing using an AI-based cascading classification system”, 2020 IEEE INTERNATIONAL CONFERENCE ON ELECTRO INFORMATION TECHNOLOGY (EIT), IEEE, 31 Jul. 2020 (2020-07-31), pages 609-614)).

US 2013/0132001 A1 relates to industrial equipment and explains fault detection and fault prediction by using models. The document discusses detailed examples and also refers to the training of the models.

### SUMMARY

Simplified, the prediction does not come from a single functional module that would receive machine data and that would provide prediction data, but the prediction comes from a module arrangement with an output module and with sub-ordinated modules. In that sense, the module arrangement is implementing a meta-model in that the output module predicts the failure by processing intermediate indicators from the sub-ordinated modules (or base models).

Arranging multiple modules in hierarchy has a consequence for training as well: the sub-ordinated modules are being trained in advance to their higher-ranking modules.

More in detail, the module arrangement has first and second intermediate modules that are sub-ordinated to an output module. At least a first and a second sub-oriented module processes machine data to determine first and second intermediate status indicators, respectively. Such status indicators can be related to the operating configurations of the industrial machine.

In parallel, a further sub-ordinated module—the operation mode classifier—receives sensor data as well and determines an operation mode of the industrial machine (operation mode indicator). The output module processes the intermediate status indicators as well as the operation mode indicator and predicts failure of the industrial machine. Compared to the mentioned single functional module, the prediction accuracy can be increased because failures are related to different operation modes.

The figures also illustrate a computer program or a computer program product. The computer program product—when loaded into a memory of a computer and being executed by at least one processor of the computer—causes the computer to perform the steps of a computer-implemented method. In other words, the program provides the instructions for the modules. Likewise, a computer system comprising a plurality of processing modules which, when executed by the computer system, perform the steps of the computer-implemented method.

The present invention relates to a computer-implemented method to predict failure of an industrial machine as claimed in claim 1. A computer-implemented method for predicting failure of an industrial machine is a method wherein the computer uses an arrangement of processing modules (For simplicity, the attribute “processing” is occasionally omitted from the text). The computer receives machine data from the industrial machine by first, second and third sub-ordinated processing modules. These modules are arranged to provide intermediate data to an output processing module. The arrangement has been trained in advance by cascaded training. By the first sub-ordinated module, the computer processes the machine data to determine a first intermediate status indicator. By the second sub-ordinated module, the computer processes the machine data to determine a second intermediate status indicator. By the third sub-ordinated module—being the operation mode classifier module—the computer processes the machine data to determine an operation mode indicator of the industrial machine. The computer processes the first and second intermediate status indicators and the operation mode indicator by the output module. Thereby, the output module predicts failure of the industrial machine by providing prediction data.

Optionally, the computer uses an arrangement that has been trained according to the following training sequence: train the third sub-ordinated module with historical machine data; run the trained third sub-ordinated module to obtain an historical mode indicator by processing historical machine data; train the first and second sub-ordinated modules with historical machine data and with the historical mode indicator; run the trained first and second sub-ordinated modules to obtain the first and second intermediate status indictors by processing historical machine data; and train the output module by the historical mode indicator, by historical machine data and by historical failure data.

Optionally, in determining the operation mode indicator, the computer uses the operation mode classifier having been trained based on historical machine data that have been annotated by a human expert.

Optionally, the expert-annotated historical machine data are sensor data.

Optionally, the operation mode classifier has been trained based on historical machine data. During training, the operation mode classifier has clustered operation time of the machine into clusters of time-series segments.

Optionally, the clusters of time-series segments are being assigned to operation modes indicators, selected from being assigned automatically or by interaction with a human expert.

Optionally, the operation mode indicators are provided by the number of mode changes over time.

Optionally, the status indicators are selected from current indicators that indicate the current status, and predictor indicators that indicate the status in the future.

Optionally, the output module predicts failure of the industrial machine, selected from the following: time to failure, failure type, remaining useful life, failure interval.

Optionally, the operation mode indicator further serves as a bias that is processed by both the first and the second sub-ordinated processing modules.

Optionally, the computer receives machine data by receiving a sub-set with sensor data and the computer determines the first and second intermediate status indicators by the first and second sub-ordinated modules that process sub-sets with sensor data.

Optionally, the computer receives machine data. This action comprises receiving the data through data harmonizers that—depending on contribution of machine data to the failure prediction—provide machine data by a virtual sensor or filter incoming machine data.

Optionally, the computer receives machine data through the data harmonizers. This action comprises receiving the machine data from harmonizers with modules that have been trained in advance by transfer learning.

Optionally, the computer receives machine data that has at least partially be enhanced by data resulting from simulation.

From a broader perspective, the present method to predict failure of an industrial machine can be applied for use cases with forwarding the prediction data to a machine controller. The controller can let the industrial machine assume a mode for which the time to fail is predicted to occur at the latest, and the controller can let/allow the industrial machine assume a mode for which the time to perform maintenance of the machine occurs at the latest.

Further, an industrial machine can be adapted to provide machine data to a computer (that is adapted to perform a method). The industrial machine can be further adapted to receive prediction data from the computer. In such scenarios, the industrial machine is associated with a machine controller that switches the operation mode of the industrial machine according to pre-defined optimization goals.

Optionally, the pre-defined optimization goals are selected from the following: avoid maintenance as long as possible, operate in a mode for that failure is predicted to occur at the latest.

The industrial machine can be selected from: chemical reactors, metallurgical furnaces, vessels, pumps, motors, and engines.

Further, there is computer-implemented method for training a module arrangement having first, second and third sub-ordinated modules coupled to an output module to enable the module arrangement to provide a failure indicator with a failure prediction for the industrial machine. The method comprises the application of cascaded training with training the sub-ordinated modules, subsequently operating the trained sub-ordinated modules, and subsequently training the output module.

Optionally, the cascaded training comprises: train the third sub-ordinated module with historical machine data; run the trained third sub-ordinated module to obtain an historical mode indicator by processing historical machine data; train the first and second sub-ordinated modules with historical machine data and with the historical mode indicator; run the trained first and second sub-ordinated modules to obtain the first and second intermediate status indictors by processing historical machine data; and train the output module by the historical mode indicator, by historical machine data and by historical failure data.

From a further perspective, a computer-implemented failure predictor has a module arrangement with first and second sub-ordinated modules that are sub-ordinated to an output module. The first and a second sub-ordinated modules process data from an industrial machine to determine first and second intermediate status indicators. A third sub-ordinated module determines an operation mode indicator, and the output module processes the status indicators and the operation mode indicator to predict a failure of the industrial machine. The module arrangement has been trained by cascaded training to comprises to train the sub-ordinated modules, to subsequently operate the trained sub-ordinated modules, and to subsequently train the output module.

### BRIEF DESCRIPTION OF THE DRAWINGS

Embodiments of the present invention will now be described in detail with reference to the attached drawings, in which:

FIGS. 1A and 1B illustrate an industrial machine and a module arrangement;

FIG. 2 illustrates the module arrangement with sub-ordinated modules in hierarchy below an output module;

FIG. 3 illustrates time-diagrams for the operation of the industrial machine in combination with failure intervals in the failure prediction;

FIG. 4 illustrates a time-diagram for the operation of the industrial machine in combination with mode-specific failure intervals in the prediction by mode-specific modules;

FIG. 5 illustrates a block diagram of an industrial machine;

FIG. 6 illustrates multi-variate time-series with historical data;

FIG. 7 illustrates a simplified time diagram for cascaded training;

FIG. 8 illustrates a simplified time diagram for cascaded training in a variation;

FIG. 9 illustrates a flowchart of a computer-implemented method to predict failure of an industrial machine;

FIG. 10 illustrates a time sequence with mode indicators for two modes, by way of example, to optionally determine mode change rates;

FIG. 11 illustrates a status transition diagram with mode transitions;

FIG. 12 illustrates a plurality of industrial machines as well as historical time-series with machine data and historical time-series with failure data;

FIG. 13 illustrates different industrial machines in an approach to harmonize the machine data (and potentially the failure data Q);

FIG. 14 illustrates machine data in a time-series with data provided by a sensor and data provided a data processor; and

FIG. 15 illustrates a generic computer.

### DETAILED DESCRIPTION

### Overview and Writing Convention

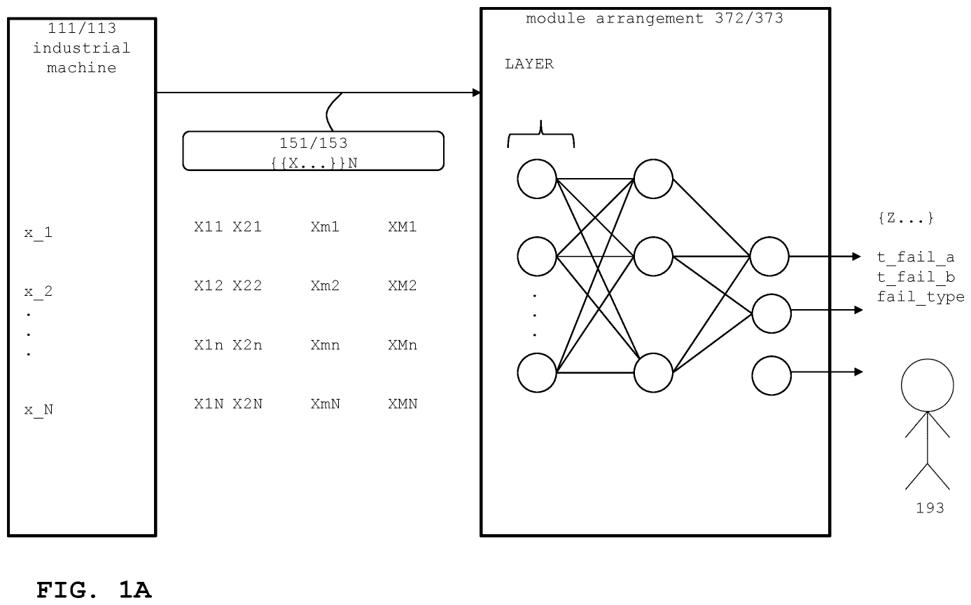

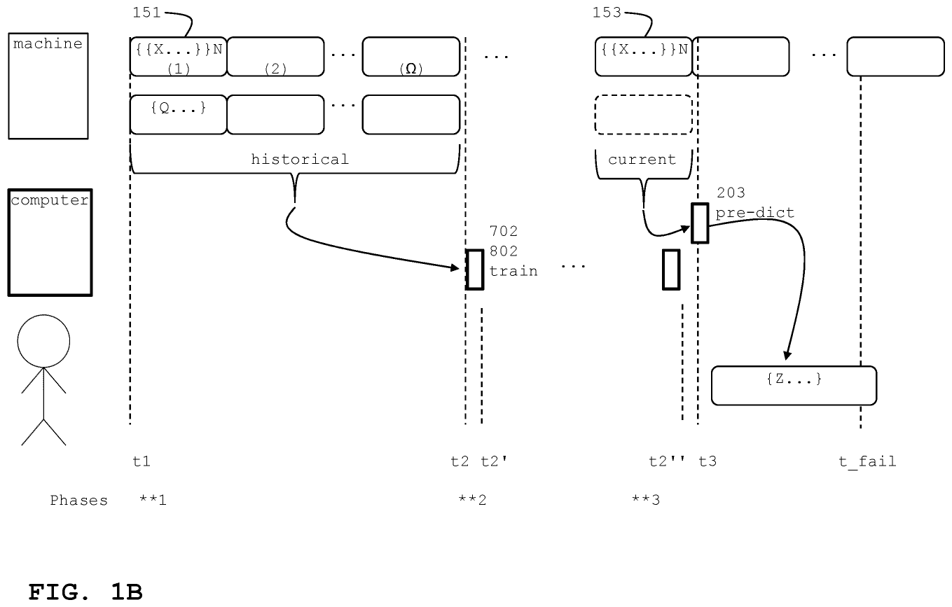

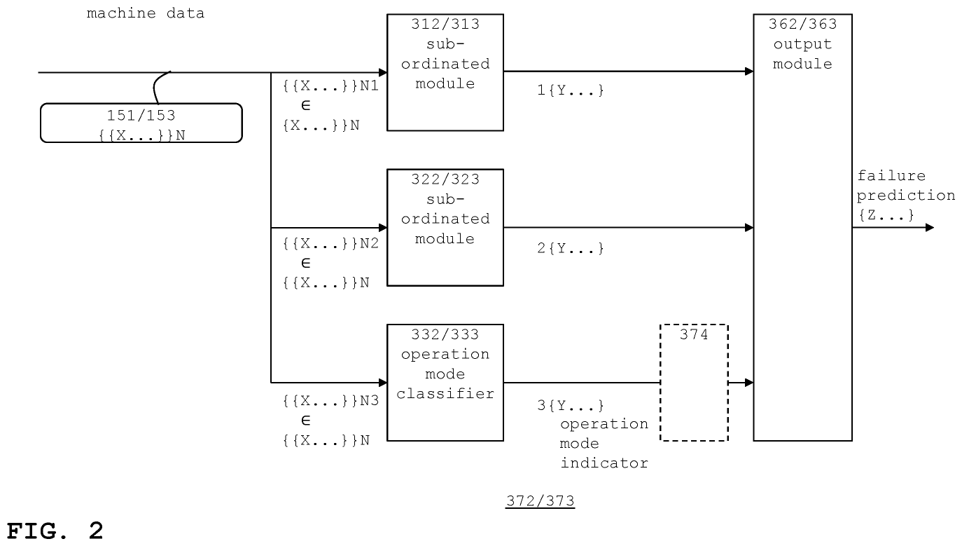

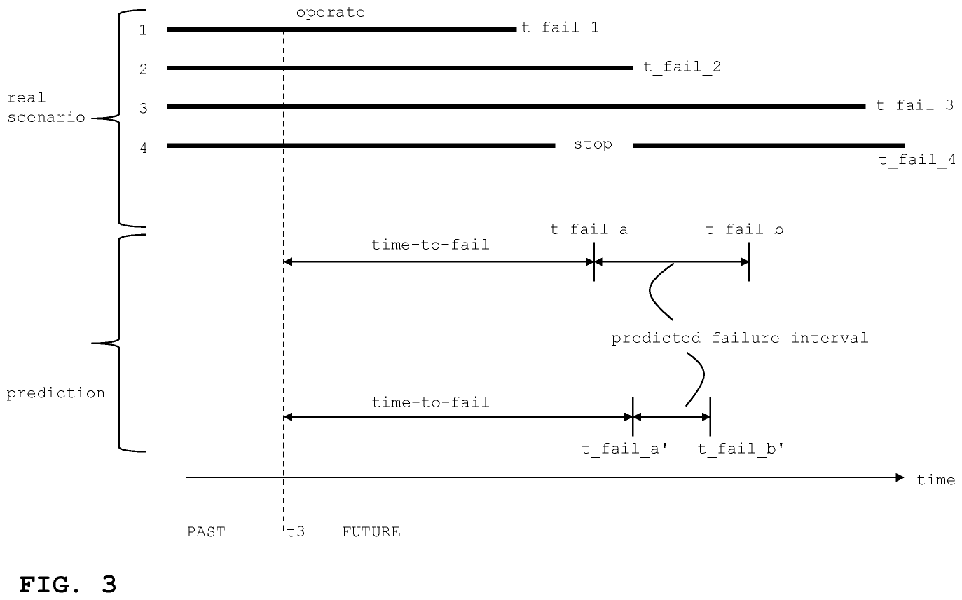

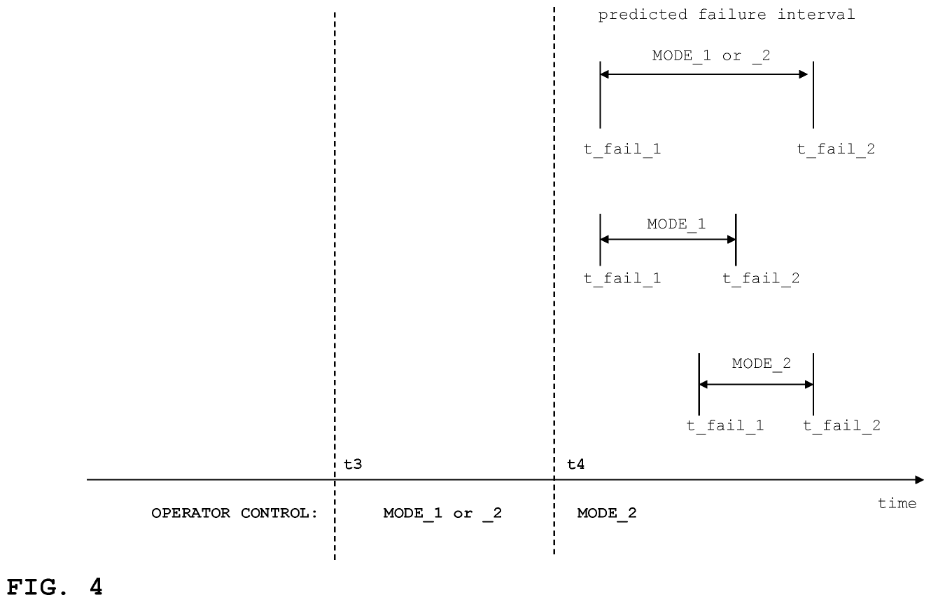

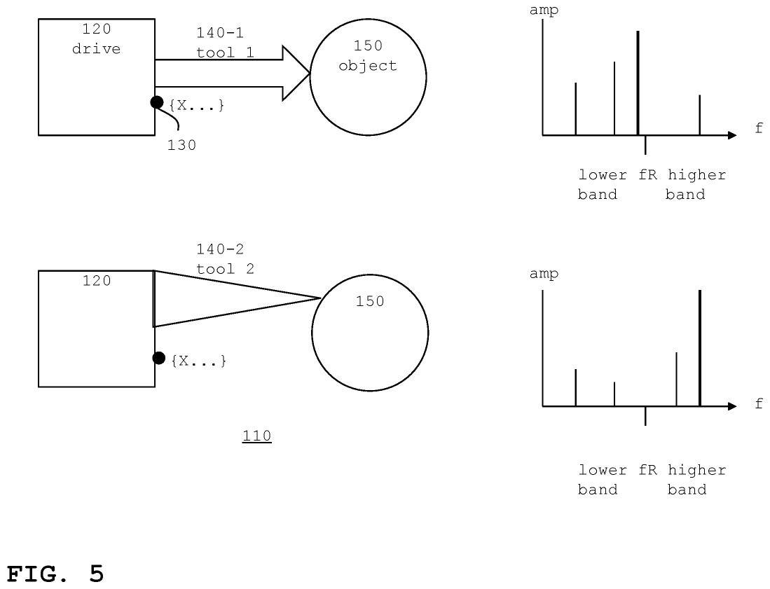

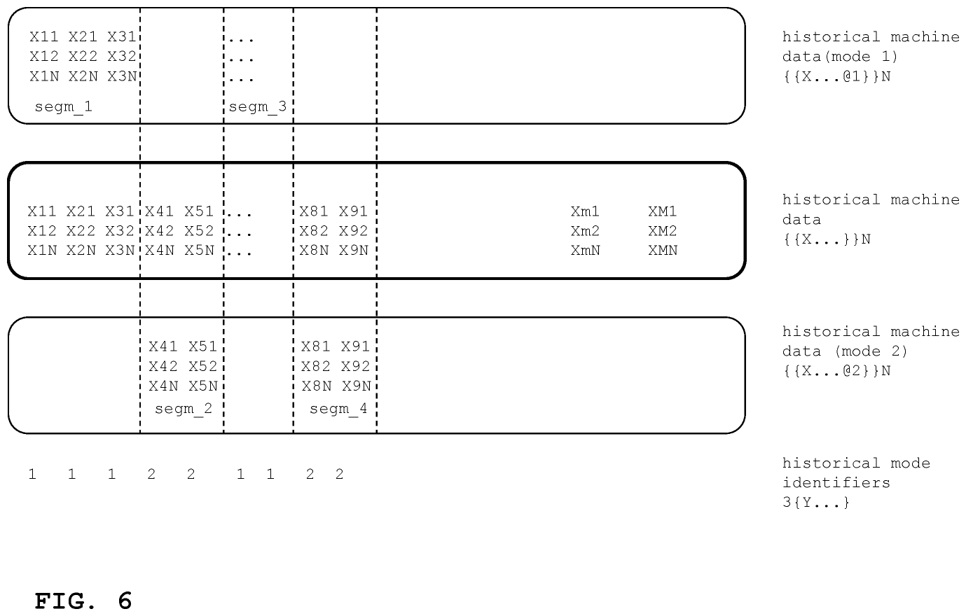

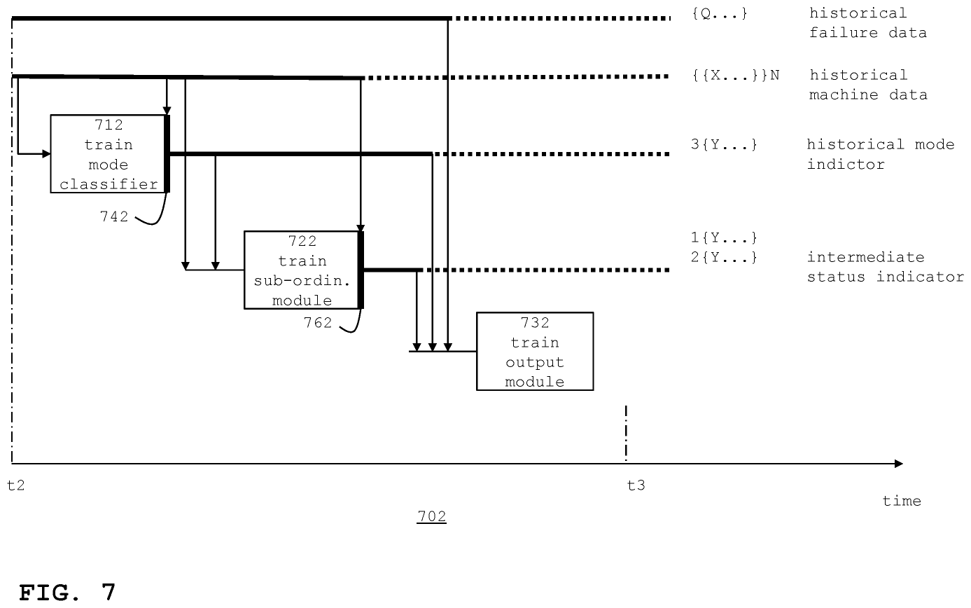

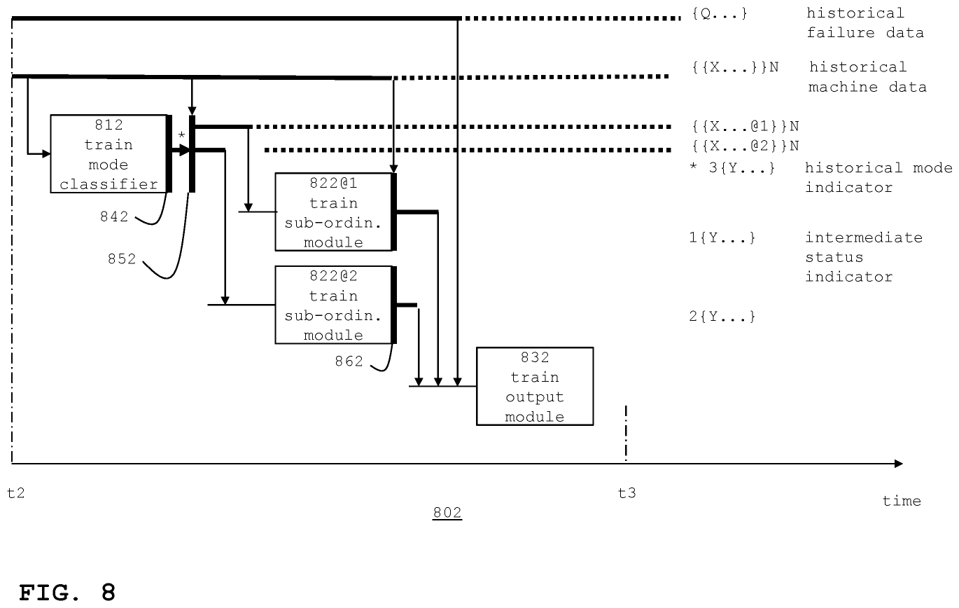

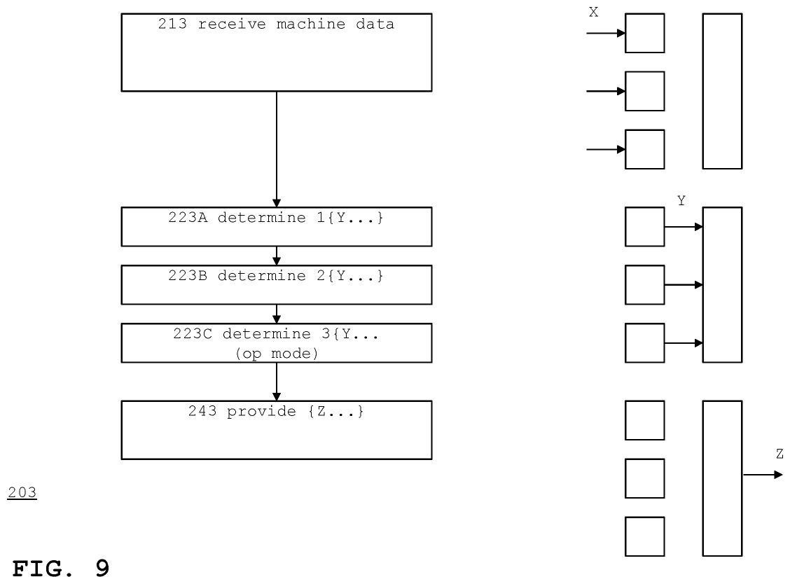

The description uses a top-down approach by illustrating an industrial machine and a module arrangement in FIGS. 1A, 1B and 2, by discussing accuracy in connection with operation modes by simplified time-diagrams in FIGS. 3-4 and by showing a detail of the industrial machine in FIG. 5. FIG. 6 discusses a time-series with machine data that is separated according to operation modes. The description will then discuss training in connection with FIGS. 7-8 and discuss prediction by the flowchart of FIG. 9. Further aspects will be given in FIGS. 10-15 as well.

The description uses phrases like “run a module” or “run a computer” to describe computer activities, and uses phrases with “operates” to describe machine activities.

### Industrial Machine and Module Arrangement

FIGS. 1A and 1B give an overview to the approach in the contexts of space (FIG. 1A) and time (FIG. 1B).

FIG. 1A illustrates industrial machine 113 and a computer with module arrangement 373. Machine 113 provides (current) machine data 153 {{X1 . . . XM}}N (or {{X . . . }}N in short) to the input of module arrangement 373. Module arrangement 373 provides (current) prediction data {Z . . . } at its output.

The notation “the computer” (in singular, without reference) stands for a computing function or for a function of a computer-implemented module. The functions can be distributed to different physical computers.

As used herein, a “module” is a functional unit (or computation unit) that uses one or more internal variables that are obtained by training.

The skilled person knows a variety of such modules, and occasionally would call them “machine learning tool” or “ML tool”. The description does not use “ML” or the like, simply because the “M” stands for computers that perform the calculation. As used herein, the (industrial) machine is related to machine data X, but the machine itself does not perform the computations.

From a different perspective, the figures illustrate the modules of a computer system comprising a plurality of processing modules which, when executed by the computer system, perform the steps of the computer-implemented method. The industrial machine is not considered to be a computer module.

The modules perform algorithms, that solve tasks such as regression, classification, clustering etc.

In view of their internal structure, they can be:
neural networks (with the variables being weights, the symbols in FIG. 1A with nodes arranged in layers),
decision tree structures with a single tree, or with multiple trees (such as random forest), or other modules.

The skilled person can implement the internal structures by using frameworks such as e. Tensorflow, libraries such as Keras, programming languages such as e.g. Python, R or Julia.

The figure also symbolizes the potential recipient of the prediction data by operator 193. The operator (or any other person who is in charge of the industrial machine) can apply appropriate measures, such as maintaining the machine in due time, letting the machine operate until failure is expected, change operation particulars to reach an operation mode in which failure occurrence would be delayed, and so on.

However, prediction data {Z . . . } can be forwarded to other computers as well so that measures can be triggered (semi) automatically.

Prediction data {Z . . . } has several aspects, such as for example
t_fail_a (future time point at which the failure is predicted to occur at the earliest),
t_fail_b (future time point at which the failure is predicted to occur at the latest),
failure_type (indication of a failure type, for example by identifying a machine component that will fail), or
the prediction of the machine operating without failure, at least during a particular time interval in the future.

FIG. 1B illustrates a matrix with the machine, the computer and the user in rows, and with the process of time in columns (from left to right). FIG. 1B can be regarded as FIG. 1A tilted by 90 degree.

Much simplified, the machine provides machine data, the computer performs methods 702, 802 and 203, and the user receives prediction data {Z . . . }.

### Phases

For convenience, the figures and the description therefore differentiates at least the following phases:
preparation phase **1 starting approximately at t1, by collecting data in time-series, while the machine is operating;
training phase **2 being performed at t2, with training the module arrangement, cf. methods 702 or 802 in FIGS. 7-8, no matter if the machine is operating in **2 or not, and
operation phase **3 indicating the operation of the machine and the collection of data that will be used to predict failures, with t3 being the time to perform the prediction in method 203 (cf. the sub-ordinated modules and the output module, FIG. 2).

### Time-Series

Data (such as machine data) can be available in the form of time-series, i.e., series of data values indexed in time order for subsequent time points. FIG. 1A introduces time-series by a short notation (“round-corner” rectangle 153) and by a matrix below the rectangle, and FIG. 1B repeats the rectangle notation in the context of time.

The notation {X1 . . . XM} stands for a single (i.e., uni-variate) time-series with data elements Xm (or “elements” in short). The elements Xm are available from time point 1 to time point M: X1, X2, . . . , Xm, . . . XM (i.e., a “measurement time-series”). Index m is the time point index. Time point m is followed by time point (m+1), usually in the equidistant interval Δt. The notation {X . . . } is a short form.

An example is the rotation speed of a machine drive over M time points: {1400 . . . 1500}. The person skilled in the art can pre-process data values, for example, to normalized values [0,1], or {0.2 . . . 1}. The data format is not limited to scalars or vectors, {X1 . . . XM} can also stand for a sequence of M images or sound samples taken from time point 1 to time point M.

The notation {{X1 . . . XM}}N (or {{X . . . }}N in its short form) stands for a multi-variate time-series with data element vectors {X_m}N from time point 1 to time point M. The vectors have the cardinality N (number of variates, i.e., parameters for that data is available), that means at any time point from 1 to M, there are N data elements available. The matrix indicates the variate index n as the row index (from x_1 to x_N).

For example, the single time-series for rotation can be accompanied by a single time-series for the temperature, a further single time-series for data regarding chemical composition of materials, or the like.

The person of skill in the art understands that the description is simplified. Realistic variate numbers N can reach and exceed a couple of 1000. Time-series are not ideal. Occasionally, an element is missing, but the skilled person can accommodate such situations.

The selection of the time interval Δt and of the number of time points M depends on the process or activity that is performed by the machine. The overall duration Δt*M of a time-series (i.e., a window size) corresponds to the machine parameter shift that takes the longest time.

As time points tm specify the time for processing by the module arrangement (or its components), some data may be pre-processed. For example, a temperature sensor may provide data every minute, but for Δt=15 minutes (for example), some data may be discarded, averaged over Δt, or pre-processed otherwise.

The time-series notation { . . . } is applicable for the following:
machine data {X . . . } as explained,
intermediate data {Y . . . } developing during processing by the computer in the modules, especially in the sub-ordinated modules,
failure prediction data {Z . . . } at the output of the module arrangement,
failure data {Q . . . } representing failures that actually occur or occurred ({Q . . . } is not a prediction).

X, Y, Z and Q data can also be available as multi-variate time-series.

However, uni-variate and multi-variate time-series are just examples for data formats, the skilled person can process the data in other formats.

### Machine Data X

As the label suggests, machine data X is related to the industrial machine. Data X is processed because the predicted failure is related to the operation of the machine. Since not all variates of the machine data do contribute to the prediction, there is a rough differentiation according to the relation of the data sources to the machine.

The machine data can be differentiated into
data obtained from sensors that are associated with the machine (“sensor data”), and
data obtained from other sources (“further data” or “feature data”).

Further data can represent the objects being processed by the machine (with properties such as object type, object material, load conditions etc.) or tools that belong to the machines (especially when they change over time). Further data can be environmental data during the operation (such as temperature). A further example comprise maintenance data.

Potentially, sensor data can be hidden from the machine operator or from other users in the sense that the operator/user does not relate particular sensor data to particular meanings. There is a consequence that expert users may not be able to label such data. Further data is potentially more open. For example, a sensor reading that represents vibration of a particular component may not have a semantic for an expert, but the expert may very well understand the influence of the environmental temperature to the machine.

### Calendar Time

As mentioned, index m is the time point index, the notation in time-series is convenient, and the skilled person can easily convert the time notation to actual calendar time points. Time-series can be available in sequences (FIG. 1B with Ω time-series in a sequence), and calendar intervals can be much longer than Δt*M.

Training and Differentiating Historical from Current Data

As the modules obtain internal variables (such as weights or other machine-learning related variables) through training 702/802 with data, the description distinguishes “historical data” from “current data”. Historical data is data that can be used to train a module (FIG. 1B with methods 702 and 802, in FIGS. 7-8). Therefore, historical data must be available before training. In other words, data illustrated to the left of method 702/802 would be historical data (historical machine data, historical failure data).

FIG. 1B illustrates training by a single box 702/802 and symbolizes the run-time between t2 and t2′ by the width of that box. It is possible to repeat training with newly arriving data (i.e., “multiplying” the box to the right, as illustrated with a box at t2″). With the progress of time, the amount of historical data rises so that the modules can be re-trained (by repeating methods 702, 802) to achieve more accurate prediction performance.

FIG. 1B illustrates consecutive time-series with indices (1), (2) . . . (Ω). It is convenient that historical data for a single overall duration Δt*M is processed at one time (i.e., N*M data values to the N*M inputs of the arrangement under training, plus M data values for Q), but the skilled person can apply the data to the modules otherwise. The number Ω (of time-series) is rising over time.

In contrast, current data is data that a trained module can process to predict a failure that can occur in the future (method 203 in FIG. 9). FIG. 1B illustrates this by time-series 153 with {{X . . . } to be processed during the execution of prediction method 203. In theory it would be possible to process current data that actually overlaps with historical data (cf. the second box ending at t2″).

### Original Data

As illustrated, the module arrangement receives original data, that is data not yet processed by a module (with the exception of pre-processing to harmonize data formats). While being trained in method 702/802, the module arrangement receives original historical data and obtains the variables (or “weights”). Once it has been trained, the module arrangement in prediction method 203 receives original current data and provides prediction data {Z . . . }. Original data is mentioned here already, because during training 702/802 and during prediction 203, the modules of the arrangement provide and process intermediate data. Generally, historical data remains historical data, and current data remains current data.

### Predicting and Differentiating Past and Future

The run-time of the computer performing prediction method 203 can be negligible/short (in comparison to the M intervals in a time-series). The description therefore takes t3 as the earliest point in time when the operator can be informed about the failure prediction {Z . . . }. FIG. 1B therefore illustrates the prediction as time-series as well. As details will be explained below, one element of failure prediction data {Z . . . } is the identification of a failure time point (t_fail).

From t3 (but not earlier), the operator can see/know the prediction.

Future time points can be also given relatively to the run-time of the computer (cf. t3, in FIG. 3). The “time-to-fail” marks the interval or duration from t3 to the earliest failure time point.

The prediction accuracy of the output can be regarded as timing accuracy, type accuracy, and so on. These aspects are related with each other. For simplicity of explanations, the description focuses on increasing the timing accuracy.

### Data Collection for Training

FIG. 1A also shows reference 111 for the industrial machine during historical operation, reference 151 for historical machine data (and historical failure data) in phase **1. It also shows reference 372 for the arrangement being trained.

### Module Arrangement

FIG. 2 illustrates module arrangement 373 with sub-ordinated modules 313, 323, 333 that (in hierarchy) are sub-ordinated to output module 363 (relatively higher-ranking). Sub-ordinated module 333 has the special function of an operation mode classifier.

The description uses the label “classifier” for simplicity of explanation, but the label comprises the meaning “clustering” as well. Sub-ordinated module 333 can operate as a classifier (that assigns operation times of the machine to classes, such as MODE_1 or MODE_2), but module 333 can also operate as a clustering tool (that separates operation times of the machine according to data that is observed during different operation times).

The assignment of particular clusters to particular modes is optional.

For example, module 333 can process data and can cluster operation time (i.e., time points m) into first and second clusters. The computer can then automatically assign these clusters to first and second operation modes (serving as the classes). In other words, there is a semantic difference between “cluster” and “mode”. The module observes the operation of the machine and differentiates operation time into (non-overlapping) clusters. There is an assignment (first cluster to first mode, second cluster to second mode, etc.), and the mode can set as a classification target. The module can then be trained to differentiate operation times according to the target (no longer clustering, but classifying). In further repetitions with different data, module 333 can then determine if the machines operates in the first or second mode.

Human experts can optionally be involved in assigning clusters to classes (for example, the expert just gives the clusters their mode names, the expert recognized relevance to failure or the like). The assignment can be more sophisticated (two clusters might belong to the same mode). But in general, involving the human expert is not required. It might be advantageous not to involve the user. The differences between operation modes might be “invisible” to the expert (or least difficult to detect, cf. FIG. 5 for an example). In other words, the clusters and/or the modes might be hidden from the experts. But differences might have an impact on the prediction (and on the operation of the machine, cf. FIG. 4), and the computer can recognize the existence of such differences. Again, the difference might be hidden from the user, but not from the computer.

Clustering is not mandatory, it is also possible that an expert annotates the operation mode to historical machine data, such as by providing annotations to sensor data.

### Different Modules

Different modules perform different tasks (such as regression and classification/clustering). The use of sub-ordinated modules (that are specialized in particular tasks) in the arrangement may increase the prediction accuracy in comparison to single modules (i.e., modules without sub-ordinated modules). Prediction accuracy will be explained by way of example for time accuracy in connection with FIGS. 3-4.

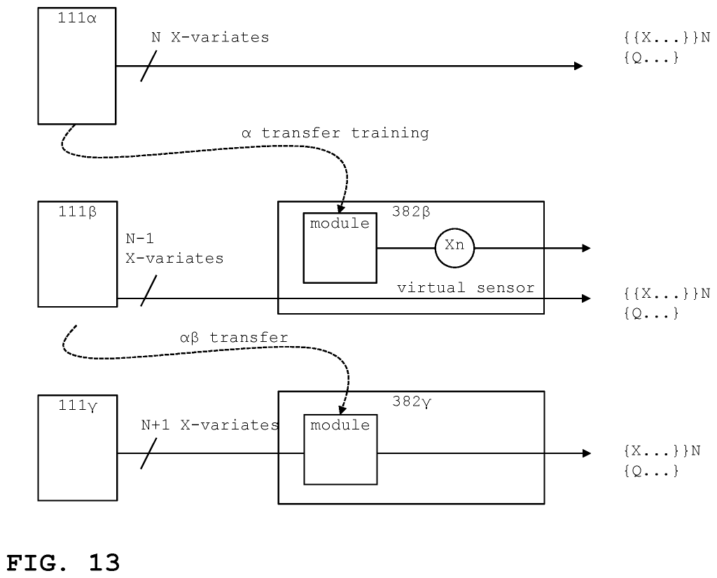

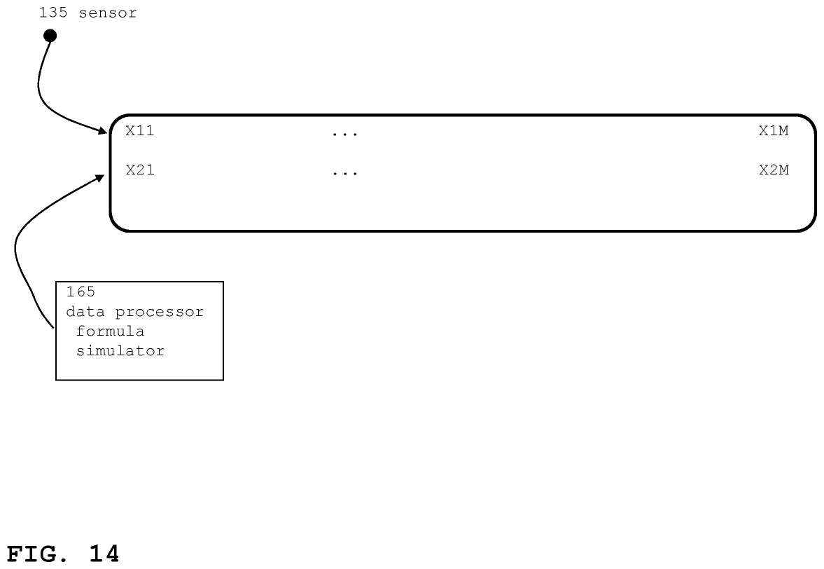

As module arrangement 373 has several components that may require particular data as input, the description below will further explain optional approaches, among them the following:
to compensate lack of data by using data from virtual sensors (cf. FIG. 13 for an approach),
to compensate lack of expert knowledge in differentiating operation modes by automatically classifying modes (cf. FIG. 7-8 for using such automatically obtained data), optionally starting by clustering,
to let the module arrangement cascade training in a particular training sequence (starting with the mode classifier, cf. FIG. 7-8),
to compensate lack of data by at least partially simulating the behavior of the industrial machine at least partly (cf. FIG. 14), or by anticipating the behavior of the machine otherwise,
enhance training data by human-annotated labels (not further illustrated),
to compensate lack of data (or surplus of data) by transferring data, such as by harmonizing the availability of data variants when data has to be processed from different physical machines (cf. FIG. 13 explained for historical data), or
to let different modules compete for accuracy, by using bias (instead of binary classification) that indicates confidence of input to train the output module (for example as explained below, disjunct mode indicator or indicator with probabilities).

From an overall perspective, module arrangement 373 receives machine data 153 from industrial machine 113 (cf. FIG. 1A) and predicts failure of the industrial machine (data {Z . . . }).

Looking at its topology, module arrangement 373 comprises two or more modules that are sub-ordinated to an output module. The sub-ordinated modules may differ (between peers) in the following:
The origin of the machine data can be module-specific. For example, sub-ordinated modules 313 and 323 can process machine data from different machine components, for example module 313 can receive {{X . . . }}N1 being a subset E to {{X . . . }}N, module 323 can receive subset {{X . . . }}N2, and so on (cf. FIG. 2).
The weight sets (or other machine-learned variables) that sub-ordinated modules apply during processing can be different.
The intermediate data (such as {Y . . . } can be module-specific as well. The figure illustrates 1{Y . . . } at the output of module 313 as first intermediate status indicator, 2{Y . . . } at the output of module 323 as second intermediate status indicator, and 3{Y . . . } at the output of operation mode classifier 333 as operation mode indicator.

The topology influences the availability of data. The output module can process intermediate data when they become available (pipeline structure, in the figure from left to right).

The topology also influences the training. As it will be explained below in connection with FIGS. 7-8, the sub-ordinated modules are being trained before the output module can be trained. The same principle applies for hierarchy with further ranks as well, for training in the order sub-sub-ordinated modules, sub-ordinated modules, and supra-ordinating modules.

The topology is adapted to the individual modules performing different tasks. For example, module 333 provides clustering (or classification to MODE) and thereby provides a bias to the output module.

### Mixed Aspects

In connection with FIG. 1, the description has already introduced modules to perform tasks such as regression, classification, clustering etc. Differentiating tasks is convenient, but not essential. Prediction failure data {Z . . . } has aspects of a regression (the time to fail obtained from the continuous time in the future), and has aspects of classification (that type of failure, or the like). Likewise, module 333 can provide mode indicators that could be disjunct (e.g., either MODE_1, or MODE_2, as the result of classification), or that could be probability classifiers (details below).

### Phases

Unless indicated otherwise, the industrial machine and the module arrangement are illustrated during the operation phase **3. Training **2 will be explained in connection with FIGS. 7-8. For convenience, FIG. 2 also illustrates the references that are applicable during training: module arrangement 372 being trained, with sub-ordinated modules 312, 322 and 322 as well as output module 362, all being trained (cf. FIGS. 7-8 for details).

FIG. 2 also illustrates optional indicator derivation module 374, to be explained in connection with FIGS. 9-10.

### Timing Accuracy in Predicting Failure Time

FIG. 3 illustrates time-diagrams for the operation of industrial machine 113 (of FIGS. 1A and 1B) in combination with failure intervals in the failure prediction by a module. The module can be a traditional module (no sub-ordination) or can be module arrangement 373.

Horizontal lines indicate the operation of the industrial machine in simplified operating scenarios.
Scenario 1: The machine operates until it fails at t_fail_1<t_fail_a. The module did not provide an acceptable indication.
Scenario 2: The machine operates until it fails during the predicted failure interval [t_fail_a, t_fail_b]. The module did provide an acceptable indication, but the operator decided not to perform maintenance of the machine.
Scenario 3: The machine operates until it fails after the predicted failure interval [t_fail_a, t_fail_b], at t_fail_3.
Scenario 4: The machine operates until a maintenance break “stop”. Maintenance starts shortly before predicted t_fail_a. The machine resumes operating, and eventually will fail at t_fail_4. This is an almost ideal situation.

There is a desire to make the prediction more accurate. The figures illustrate this by a modified predicted failure interval [t_fail_a′, t_fail_b′] that would be shorter that its original. The operator could delay maintenance until shortly before t_fail_a′. Such an improvement is feasible for a module arrangement (cascading modules, cf. FIG. 2).

The module arrangement operates at run-time t3 (cf. FIG. 2) and the duration of the computation can be neglected (the time it takes for the computer to calculate {Z . . . }). The interval [t_fail_a, t_fail_b] is the predicted failure interval.

The illustration is simplified, the person of skill in the art can derive other metrics, among them:
Remaining Useful Life (RUL). Failures can be different, and not all failure types put the machine out of service. For example, an indication “no oil” for a bearing give the operator the opportunity to carry out maintenance of that bearing and the machine can continue to operate. The operator would obtain RUL by collecting further data that indicates failures going beyond the simple lack of oil (such as motor failure).
Time to Failure (TTF) would be the interval (from t3) to t_fail_a (short TTF) or to t_fail_b (long TTF).
The failure risk as an indication of severity, which can be derived from t_type (optionally, by taking the time into account as well).

As it will be explained, a single module that receives data from substantially all available machine data {{X . . . }}N might provide prediction data {Z . . . } that is not suitable for the operator to make the appropriate decisions.

FIG. 4 illustrates a time-diagram for the operation of the industrial machine (of FIG. 1A) in combination with mode-specific failure intervals in the prediction by mode-specific modules.

The module arrangement can differentiate predicted failure intervals by modes, the figure illustrates (t_fail_1, t_fail_2) for MODE_1 and for MODE_2 separately.

Machine operators could understand operation modes to reflect easy-to-detect states such as ON (machine is operating), STAND-BY (machine is operating at low energy but without providing products or the like), FULLY-LOADED or the like. But the modes are related to predicted failures, and the operator does not have to be aware that the machine switches modes. There is even no requirement for the machine to implement a mode switch. The modes are attributes that represent the operation of the machine.

In the simplified example, the machine in MODE_1 would fail earlier than the machine in MODE_2. That information can be important for the operator. As illustrated below, at t3 (the operation time of the module arrangement), the operator is informed about the predicted failure intervals, for both modes separately, and optionally for both modes in combination (“MODE_1 OR_2”).

While until t3, the operator could control the machine to operate in MODE_1 or in MODE_2, or the machine assumed any of the modes without being explicitly controlled to take a particular mode.

Possibly, the operator could continue with MODE_2 until t4 (shortly before t_fail_1 for MODE_1. Maintenance could be delayed, or from approximately t4 the operator allows the machine to operate in MODE_2 only.

The illustration is much simplified, during the operation of the machine after t3 (represented by current data taken from t3 to t4), the computer would update the prediction. Continuing to operate the machine in MODE_1 (after t3) may possibly move t_fail (for MODE_1) to the left. Therefore, the operator might decide switching to MODE_2 only shortly after t3 already (and not at t4).

It is noted that the operator does not have to know the mode in advance, he could switch the machine to operate differently, and the mode indicator would tell him or her the mode.

The module arrangement that differentiates operation modes can be more precise in identifying the (overall) failure interval. The description explains details to enhance prediction precision in connection with FIG. 5 but takes a short excurse to an application scenario in which failure prediction data {Z . . . } and mode identification data in combination can be used to control the machine.

### (Semi) Automatic Mode Adaptation

FIG. 4 and its explanation can be taken as an example for establishing control rules. A machine controller can process failure prediction data {Z . . . } (available at t3) to actual control commands to control the operation of the machine. The rules could be enhanced by higher-level optimization goals. For example, for an optimization goal “avoid maintenance as long as possible”, the controller would let the machine operate until t4 in any mode, but would not allow operation in MODE_1 from t4.

The involvement of human expert would be minimal (for example, to define t4 to be prior to t_fail with some pre-defined window).

The controller sending control commands to the machine might change the mode. But at substantially any time, the (trained) module arrangement (or at least its mode classifier) could establish the mode (or at least the cluster) so that commands can be reversed if needed. Or, the controller checks its commands for potential influence to the mode.

In other words, the prediction performed by the arrangement (method 203 cf. FIG. 1B) can be used by forwarding {Z . . . } to the machine controller that lets the machine assume a mode for which the time to fail is predicted to occur at the latest, to assume a mode for which the time to maintain occurs at the latest, or according to other criteria.

From a different perspective, the industrial machine can be associated with a machine controller that switches the operation mode according to pre-defined optimization goals. The mentioned criteria can also be formulated as goals, such as to avoid maintenance (as long as possible), to operate the machine in a mode for which failure is predicted to occur at the latest (compared to other modes).

### Example for a Machine

FIG. 5 illustrates a block diagram of an industrial machine 110. The machine is fictitious in the sense to have symbolic components that represent real components in real machines. Examples for non-fictitious machines comprise chemical reactors, metallurgical furnaces, vessels, pumps, motors, and engines.

Machine 110 has a drive 120. A vibration sensor 130 is attached to the drive and provides a signal in form of a time-series {X . . . }. In this simplified example, machine data should comprise sensor data only. The machine uses a replaceable tool (or actuator) 140-1/140-2. The figure symbolizes the tool by showing the machine alternatively operating with tool 1 or with tool 2 (the “arrow tool” or the “triangle tool”). The machines interact with an object 150 (here in the example through the tool). During the interaction, the object should change its shape (the machine is for example a metalworking lathe), its position (transport machine), color (paint robot) or the like.

In the simplified illustration of FIG. 5, the selection of the tool determines the machine configuration (such as first and second configuration). In more realistic scenarios, the machines can have much more components that lead to multiple configurations. Configuration complexity increases the complexity of the above-mentioned cause-effect relations, and therefore the complexity of the failure prediction. For simplicity, the description focuses on vibrations as the only assumed cause for potential failure. The occurrence of mechanical vibrations (represented by signal {X . . . }) during operation is normal. Much simplified, industrial machines emit sounds. Depending on the tool/object combinations or configurations, the sound emitted by the machine is different (cf. the different frequency diagrams).

The figure also illustrates much simplified frequency diagrams (obtained, for example by Fast Fourier Transformation of the sensor signal, well known in the art). Of course, the frequency distribution will change over time, for many reasons (e.g., the object will change its shape) but the diagram gives an approximate view to the prevailing frequencies.

In general, vibrations should not always lead to failure. However, there is a notable exception. At natural frequency (or resonance frequency, here fR), the vibrations have relatively high amplitudes thus leading to an increased failure risk. Again, the description simplifies: realistic scenarios know different resonance frequencies.

As illustrated, by using tool 1 (“arrow”) the machine may vibrate near the resonance frequency, and by using tool 2 (“triangle”) there are vibrations at other frequencies. This simplified view does not exclude the risk that the machines eventually vibrates at fR, but for tool 1 the risk is higher. A minor variation (in some properties such as Young modulus of elasticity of the tool, or the like) may occur and the vibration may go to fR.

A domain expert could potentially investigate the vibrations and find a correlation between using different tools and different frequencies. However, in the mentioned realistic scenarios, with industrial machine being more complex (many different tools, many different objects), expert knowledge is generally not available.

As will be explained, the computer can differentiate between operating modes (or at least cluster the operation time), even between modes that an expert would not distinguish. The description is simplified to first and second operation modes, and the tool semantics do not matter for the computer.

In the simplified example, two operation modes are differentiated by different shares of frequencies. Much simplified, the frequencies prevail in the lower band (below fR) for the first mode, and frequencies prevail in the higher band (above fR) for the second mode.

The resonance frequency can be reached in both modes, although with different probabilities.

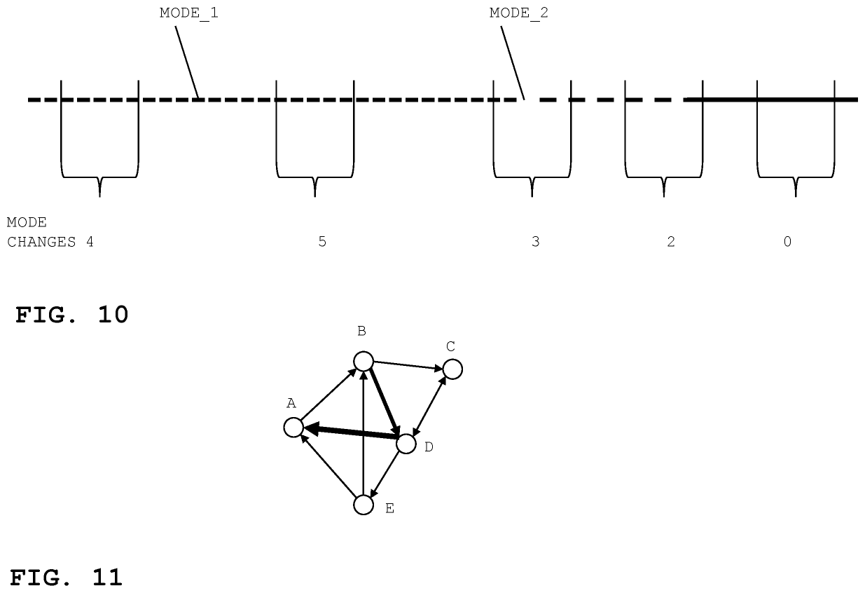

Returning to FIG. 2, operation mode classifier 333 provides operation mode indicator 3{Y . . . }. Although the description uses the term “indicator” in singular, it is noted that it can change over time. It is therefore given as a time-series. Examples for 3{Y . . . } changing over time are given in FIGS. 10-11.

In principle there are multiple options.
Operation mode classifier 333 can operate as an exclusive classifier that outputs a variable that corresponds to the operation mode (e.g., mode 1 XOR mode 2). Or, in case of multiple operation modes, operation mode classifier 333 is a pre-defined value from a set of values {MODE_1, MODE_2, MODE_3 and so on). In an alternative, the number of modes is not pre-defined but determined as the number of clusters.
Operation mode classifier 333 can operate as a probability classifier that outputs a variable with a probability of an operation mode (e.g., mode 1 at 80% and mode 2 at 20%).
Operation mode classifier 333 can be a combination of both: It could be a combination of a pre-defined value with a probability range. For example, 3{Y . . . } can be implemented as a vector with two variables, a bi-variate time-series 3{{Y . . . }2: the first variable indicates the mode, and the second variable indicates the probability. For example, for a given point in time tm, the mode would be MODE_1 at 80% probability.

### Optionally Splitting Historical Machine Data

Assuming that operation mode classifier 332/333 (cf. FIG. 2) has already been trained, at least by preliminary training, it could process historical machine data {{X . . . }} N (multi-variate time-series, or {{X . . . }}N3) to historical machine data in two sub-series. Details for that will be explained in connection with FIGS. 6 and 8.

FIG. 6 illustrates historical multi-variate time-series {{X . . . }}N as in FIG. 1B. The operation mode classifier can differentiate the modes (here MODE_1 and MODE_2) in operation mode indicator 3{Y . . . }.

As a result, X-data can be distributed to two (or more) multi-variate time-series. In the example, MODE_1 was detected for m=1, 2, 3, . . . and MODE_2 was detected for m=4, 5, 8, 9.

Variations are applicable. For example, of the mode distinction can only be established with relatively low probability (cf. the above discussion), particular data can be allocated to both modes.

For the mode-specific time-series, the left-out time slots can be disregarded so that the time appears to progress with consecutive time-slots. The skilled person can introduce new time counters or the like.

In that sense, historical data {{X . . . }}N turns into mode-annotated historical data {{X . . . @1}}N and {{X . . . @2}}N. Supervision by human experts is however not required.

Although not illustrated herein, the split can be applied to failure data as well. There would be historical failures that occurred during operation in mode 1, or during mode 2.

Splitting historical machine data (or failure data) can be used in step 852 of FIG. 8.

Splitting historical data (machine or failure data) can be considered as clustering. Clustering results in time-series segments that can be differentiated (e.g., by 3{Y . . . }). It is convenient to automatically assign particular clusters to particular modes. The example uses two clusters assigned to two modes.

The figure illustrates—by way of example only—segm_1 (in MODE_1), segm_2 (in MODE_2), segm_3 (again MODE_1), segm_4 (again MODE_2) and so on. The time-series segments may have different duration (e.g., segm_1 with 3*Δt, segm_2 with 2*Δt and so on). The segments would be separated into the first cluster with (segm_1, segm_3, . . . ) and the second cluster with (segm_2, segm_4, . . . ).

Clustering in view of separating the operation time (of the industrial machine) into different clusters is convenient because the operation mode is a function of time (3{ . . . } is a time-series).

### Original Data Revisited

As mentioned above (FIG. 1B), a module can be trained and subsequently used to process data. During training the module arrangement (cf. FIG. 2 with a two-layer hierarchy), the sub-oriented modules convert original data (machine data {X . . . }, failure data {Q . . . } etc.) to intermediate data {Y . . . }, all being historical data. The output module processes intermediate and original data, also being historical data.

Once the module arrangement has been trained, it receives original data (such as {{X . . . }}N) and provides the prediction {Z . . . }, being current data. However, at least the output module can receive original data and intermediate data, both being current data.

It may be advantageous
that the higher-ranking modules (such as the output module) receive original data (i.e., not-yet processed data) in combination with intermediate data,
that the intermediate data has a particular function, and
that the availability of such intermediate data is cascaded (during training and during prediction).

At least one example scenario is given. As annotating original data by human experts is difficult, intermediate data—such as the mode indicator—can act as a de-facto annotation. The sequence remains intact: the output module would use the de-facto annotations when they are available, not earlier.

The approach will be explained for a two-layer hierarchy (cf. FIG. 2), but further layers can be introduced.

### Cascaded Training

FIG. 7 illustrates a simplified time diagram for cascaded training 702. Bold horizontal lines indicate the availability of data during training. Vertical arrows indicate the use of data during training. Although multiple vertical lines may originate from one and the same horizontal line, this does not mean that the use requires the same data. Occasionally, data use in repetitions may imply the use from different variates (cf. {{X . . . }}N potentially not from all N variates, but from different variate subsets). Once data has been used, they remain available: the horizontal lines turn from plain to dotted lines. Re-using the data is convenient in case that some training steps are repeated.

The time progresses from left to right, with time point t2 indicating the start of phase **2, and time point t3 in operation phase **3 (cf. FIG. 3, t3 marks the run-time of the computer to perform prediction).

Boxes symbolize method steps 712, 722, 732, but the width of the boxes is not scaled to the time. On the right sides, the boxes may have bold vertical lines 742 and 762 symbolizing that a trained (sub-ordinated) module is being run to provide output.

The description occasionally refers back to FIG. 1A (reference 111 for the machine, providing historical machine data 151), to FIG. 2 (topology, the **2 references apply) and FIG. 5 (machine example with two modes).

The description uses the term “preliminary” to indicate optional repetitions of method steps. In other words, individual training steps can be repeated. For convenience, the description refers to data semantics (e.g., frequency or failure at fR), but the computer does not have to take such semantics into account.

Historical data is available from the beginning (i.e., before t2). Historical data can have, for example, the form of time-series. The figure differentiates historical data into historical failure data {Q . . . } and historical machine data {{X . . . }}N (received from industrial machine 111, or from a different machine).

Although failure data is given as a uni-variate time-series {Q . . . }, different failure types (i.e., failure variates) could be represented by a multi-variate time-series (such as {{Q . . . }}).

### Steps 712/742

In step 712, the computer uses historical machine data (and optionally failure data, not illustrated) to (preliminarily) train the mode-classifier (i.e., sub-ordinated module 333 in FIG. 2). Once trained, operation mode classifier 333 can use the historical machine data to calculate historical mode indicators 3{Y . . . }. For this step, supervision (i.e., processing expert annotations) is not required.

In step 742, the computer calculates historical mode indicators 3{Y . . . }. As historical machine data {{X . . . }}N is available in synch to historical mode indicators 3{Y . . . }, the time points tm are not changed, both data form data pairs (in the sense of automatically generated annotations, here with mode indicators).

For example, 3{Y . . . } could be a time-series that indicates alternative operation mode 1 during a first 24 hour interval and mode 2 during a second 24 hour interval.

It may be advantageous that identifying the reason (such as the use of tool 1 or 2 or other semantics) is not required. The computer uses data that is available, but training with supervision or other forms of expert involvement is not required.

### Steps 722/762

In step 722, the computer uses historical machine data {{X . . . }}N and (optionally) historical mode indicator 3{Y . . . } to train sub-ordinated modules 313, 323. Once trained, sub-ordinated modules 313, 323 can provide intermediate status indicators 1{Y . . . } and 2{Y . . . }. For example, intermediate status indicators 1{Y . . . } and 2{Y . . . } could be values that indicate frequency changes, such as increase or decrease over time.

Although the figure illustrates this step by a single box, the step is performed for both sub-ordinates modules separately (serially or in parallel).

In step 762, the computer uses historical machine data {{X . . . }}N again to calculate intermediate status indictors 1{Y . . . } and 2{Y . . . }, of course historical indicators. For example, both intermediate status indictors indicate an historical increase in the frequency. (Although the semantic does not matter)

### Step 732

Historical failure data Q (real failure data) is available, even earlier, but it can be used, potentially to compare to the intermediate status indicators. Such failure data can be obtained automatically. In a straightforward implementation, a failure would be represented by a sensor signal {Q . . . }, again as time-series indicating the time of failure (of the actual occurrence).

In step 732, the computer uses historical failure data {Q . . . }, intermediate status indicators 1{Y . . . } and 2{Y . . . } and mode indicator 3{Y . . . } to train output module 362.

By training, output module 362 turned into output module 363 (FIG. 2), and the sub-ordinated modules turn into modules with references **3 as well. To stay with the example semantics, module arrangement 373 would be able to detect failure in MODE_1 for increasing frequencies with t_fail_a and t_fail_b to occur between 10 and 14 hours from a mode change (the frequency just approaches fR). For MODE_2, the frequencies rise as well (but away from fR) and t_fail would be different.

In other words, by differentiating operation modes, module arrangement 373 is able to provide the prediction with increased timing accuracy.

Cascaded Training with Split Historical Data

FIG. 8 illustrates a simplified time diagram for cascaded training 802 in a variation of the training explained for FIG. 7.

The steps correspond to the step explained for FIG. 7, but the computer performs an additional step 852 (to split historical machine data, cf. FIG. 6) and step 722 (in FIG. 7) is performed as step 822@1 for sub-ordinated module 312/313 and as step 822@2 for sub-ordinated module 322/323.

Once (in step 812), the mode classifier module has been trained, the computer calculates historical mode indicators 3{Y . . . } in step 842. 3{Y . . . } is then used to split historical machine data into mode-annotated historical data {{X . . . @1}}N and {{X . . . @2}}N, as explained with FIG. 6. (Steps 842 and 852 can be implemented in combination.)

The sub-ordinated networks are subsequently trained separately (step 822@1, 822@2) to provide intermediate status indicators 1{Y . . . } and 2{Y . . . }.

It is convenient not to split historical failure data {Q . . . }. (A failure caused by circumstances in MODE_1 can occur when the machine operates in MODE_2, and vice versa.)

### Method Overview

FIG. 9 illustrates a flowchart of computer-implemented method 203 to predict failure of an industrial machine. In performing method 203, the computer uses an arrangement of processing modules, such as module arrangement 373 of FIG. 2) or an arrangement with further hierarchy layers. For convenience, the figure illustrates the flowchart together with a symbolic copy of FIG. 2 with X, Y and Z data.

In receiving step 213, the computer receives machine data ({{X . . . }}N) from industrial machine 113 by first, second and third sub-ordinated processing modules 313, 323, 333 that are arranged to provide intermediates data 1{Y . . . }, 2{Y . . . }, 3{Y . . . } to output processing module 363. Arrangement 373 has been trained in advance by cascaded training, cf. 702/802 in FIGS. 7-8.

The computer uses first sub-ordinated module 313 to process 223A the machine data to determine a first intermediate status indicator 1{Y . . . }; uses second sub-ordinated module 323 to process 223B the machine data to determine second intermediate status indicator 2{Y . . . }; and uses third sub-ordinated module 333—being the operation mode classifier module—to process 223C the machine data to determine operation mode indicator 3{Y . . . }, of the industrial machine 113 (for all tree indicators).

In processing step 243, the computer processes the first and second intermediate status indicators 1{Y . . . }, 2{Y . . . } and operation mode indicator 3{Y . . . } by the output module 363. Thereby, output module 363 predicts failure of industrial machine 113 by providing prediction data {Z . . . }.

### Operating Example

Module arrangement 373 now receiving current machine data 153 (cf. FIGS. 1-2) would—for an actual point in time t3 (cf. FIG. 3)—identify the mode (module 333) and status indicators (modules 313, 323).

### Selection of Machine Data

As mentioned, machine data {{X . . . }} can be sensor data and further data.

Assuming that a human expert can't select a subset of machine data that is relevant (for failure prediction). The selection is therefore made by the modules (while they are being trained). Some machine data may be processed with more weight, some other sensor data may be processed with less weight.

For non-sensor data, human experts may have more insight to make a selection (in that case, the expert could label some data as not relevant)

In implementations, subsets {{X . . . }}N1 and {{X . . . }}N2 can be further divided by grouping time-series according to variates, cf. the element-of-notation ∈ in FIG. 2.

### Using Module-Derived Indicators (Such as the Mode Indicator)

In modern industrial settings it can be expected that industrial machines change their operation mode frequently. One reason can be the trend to smaller production series. Mode changes rate (the number of mode changes per time) can be related to failures, not for all machines, but for some machine.

### Mode Changes as Derivative Mode Indicators

FIG. 10 illustrates a time sequence with mode indicators 3{Y . . . }, for two modes (MODE_1 “black” and MODE_2 “white”). Time-windows (equal duration, with a pre-defined number of time intervals Δt per window) are related to the number of mode changes (from MODE_1 to MODE_2 or vice versa). The approach can be considered as the derivation over time of a mode function.

The computer can determine the mode change rates by processing the output of the operation mode classifier (cf. FIG. 2), and the rate can be a further input value to output module 363. Mode change rates can be calculated for current data and for historical data. To symbolize this optional operation, FIG. 2 shows mode indicator derivation module 374 between classifier 333 and output module 363.

While FIG. 10 is simplified by showing two modes only, mode changes can be quantified for other scenarios as well.

In an alternative, the number of time intervals does not have to be pre-defined. Clustering is possible as well, to identify clusters according to different window durations and/or to different mode change occurrences.

FIG. 11 illustrates a status transition diagram (with 5 modes or states), and with mode transitions. One diagram would be applicable to one time-window (of FIG. 10) and could indicate the occurrence of mode transitions (e.g., A to B, B to C, C to D and vice versa, etc.). The figure symbolizes transition occurrence numbers by the thickness of the lines, with D to A being the prominent transition. Of course, during other time-windows the numbers can change. Again the transition occurrence number per specific transition can be input to output module 362/363.

The calculation can be performed, for example, by indicator derivation module 374 (cf. FIG. 2).

In an alternative, clustering is possible here as well, such to cluster the transitions and, for example, to differentiates modes with high or low sub-mode transitions.

Multiple Machines that Provide Historical Data

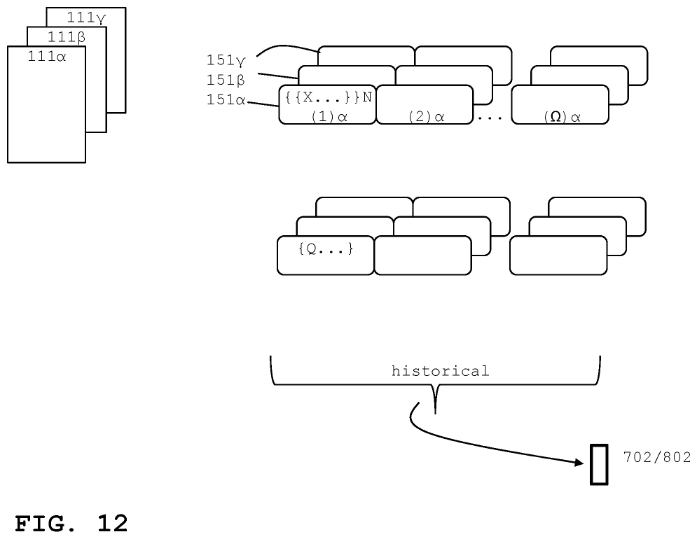

FIG. 12 illustrates a plurality of industrial machines 111α, 111β and 111γ as well as historical time-series with machine data {{X . . . }}N and historical time-series with failure data {Q . . . }. For simplicity, the figure does not use all available indices.

As mentioned above, data may not be available in sufficient quantities. The figure therefor illustrates multiples industrial machines providing historical machine data X and historical failure data Q. The figure symbolizes that—under ideal conditions—the time-series with the data would be available in a number that is the number of time-series per machine multiplied with the number of machines (having 3 machines α, β, γ is just simplified).

For training in method 702/802, the computer (arrangement 372 under training) would process a time-series {{X . . . ]}}N and a time-series {Q . . . } at N+1 input variates at one time. The computer would then turn to the next time-series.

Potentially the computer would process consecutive time-series (1), (2) to (Ω), such as {{X . . . }}N as well as {Q . . . } in the “one-time input” mentioned for FIG. 1B. The skilled person can arrange the repetition for α, for β for γ, or even let the computer process α {{X . . . }}N, β{{X . . . }}N, γ{{X . . . }}N, α{Q . . . }, β{Q . . . }, γ{Q . . . } at once. Other processing options are also available.

Compensating Missing Variates by Enhancing with Virtual Sensors and Transfer Learning

Scenarios with multiple machines, such as the scenario described in FIG. 12 would ideally operate with machine data (and failure data) from substantially equal sources.

For example, the uni-variate time-series α{X . . . }n would be similar to uni-variate time-series β{X . . . }n because the sensors for the variate n would be sensors of the same type, both in machines α and β. However, not all machines are equipped with the same sensors. The description now explains an approach to address such constraints.

FIG. 13 illustrates different industrial machines in an approach to harmonize the machine data (and potentially the failure data Q). Harmonization is applicable for historical data (phase **1) and for current data (phase **3).

The figure repeats industrial machines 111α, 111β and 111γ (from FIG. 12), but indicates different availability of machine data. Machine α should have a usual number of N variates, machine β should lack one variate (N−1 variates), and machine γ should have a higher number of variates (N+1 variates).

The figure illustrates data harmonizers 382β and 382γ. Data harmonizer 382B provides missing data by a virtual sensor (here Xn), and data harmonizer 382γ filters the incoming data (i.e., taking surplus data out).

The figure is simplified, lack and surplus of data depends on the contribution of particular variates to the prediction. Some machine data (i.e., some variates in that data) are simply not relevant to predict failure.

Both harmonizers employ modules that have been trained in advance (in terms of phases that would be **1), by transfer learning. For example, machines α and γ can be the masters to let harmonizer 382β learn how to virtualize sensor Xn. Or, machines α and β would be the masters for learning that a particular data set can be ignored.

As illustrated, the harmonizers would not change the failure data {Q . . . }.

A domain adaptation machine learning model, which has been trained by transfer learning, processes historical machine data (obtained as multi-variate time-series from a plurality of industrial machine of a particular type, but of multiple domains). The historical machine data reflect states of respective machines of multiple domains. Typically, several hundred or thousands of sensors per machine are measuring operating parameters such as, for example, temperature, pressure, chemical contents etc. (cf. the relatively high variate number N). Such measured parameters at a particular point in time define the respective state of the machine at that point in time. Due to multiple characteristics of each machine (e.g., operating mode, size, input material such as material composition, etc.), it is not possible to directly compare two machines (source and target machines) without applying a dedicated transformation of the multi-variate time-series data.

Different approaches to transfer learning can be used. For example, a domain adaptation machine learning model may be implemented by a deep learning neural network with convolutional and/or recurrent layers trained to extract domain invariant features from the historical machine data as the first domain invariant dataset. The transfer learning can be implemented to extract domain invariant features from the historical machine data. A feature in deep learning is an abstract representation of characteristics of a particular machine extracted from multi-variate time-series data which were generated by the operation of this particular machine. By applying transfer learning, it is possible to extract domain invariant features from multiple real-world machines that are independent of a specific type (i.e., independent of the various domains).

In an alternative approach, the domain adaptation machine learning model has been trained to learn a plurality of mappings of corresponding raw data from the plurality of machines into a reference machine. The reference machine can be a virtual machine which represents a kind of average machine, or an actual machine. Each mapping is a representation of a transformation of a respective particular machine into the reference machine. In this approach, the plurality of mappings corresponds to the first domain invariant dataset. For example, such a domain adaptation machine learning model may be implemented by a generative deep learning architecture based on the CycleGAN architecture. This architecture has gained popularity in a different application field: to generate artificial (or “fake”) images. The CycleGAN is an extension of the GAN architecture that involves the simultaneous training of two generator models and two discriminator models. One generator takes data from the first domain as input and outputs data for the second domain, and the other generator takes data from the second domain as input and generates data for the first domain. Discriminator models are then used to determine how plausible the generated data are and update the generator models accordingly. The CycleGAN uses an additional extension to the architecture called cycle consistency. The idea behind is that data output by the first generator could be used as input to the second generator and the output of the second generator should match the original data. The reverse is also true: that an output from the second generator can be fed as input to the first generator and the result should match the input to the second generator.

Cycle consistency is a concept from machine translation where a phrase translated from English to French should translate from French back to English and be identical to the original phrase. The reverse process should also be true. CycleGAN encourages cycle consistency by adding an additional loss to measure the difference between the generated output of the second generator and the original image, and the reverse. This acts as a regularization of the generator models, guiding the image generation process in the new domain toward image translation. To adapt the original CycleGAN architecture from image processing to the processing of multi-variate time-series data for obtaining the first domain invariant dataset the following modifications can be implemented by using recurrent layers (LSTM as an example) combined with Convolutional layers to learn the time dependency of the multi-variate time-series data as described in detail in C. Schockaert, H. Hoyez, (2020) “MTS-CycleGAN: An Adversarial-based Deep Mapping Learning Network for Multivariate Time Series Domain Adaptation Applied to the Ironmaking Industry”, In arXiv: 2007.07518.

An overview to transfer learning is available from the following: Fuzhen Zhuang, Zhiyuan Qi, Keyu Duan, Dongbo Xi, Yongchun Zhu, Hengshu Zhu, Hui Xiong, Qing He: “A Comprehensive Survey on Transfer Learning” arXiv:1911.02685

### Compensating by Simulation

FIG. 14 illustrates machine data in a bi-variate time-series {{X . . . }N for N=2 with a first time-series provided by sensors 135 (as in the normal situation, cf. sensor 130 in FIG. 5) and a second time-series provided by data processor 165.

For example, the tool (140 in FIG. 5) would lose sharpness over time. There may be no sensor available to measure that, and setting up a virtual sensor may be difficult as well (a master might be missing, because measuring the sharpness is difficult).

Data processor 165 can be implemented by a computer that uses expert-made formulas. For example, human experts can relate existing data to calculate the decrease of the sharpness over time (and hence a point in time when the tool would have to be replaced (or sharpened). By way of example, such data can comprise, the time the tool has been inserted into the machine, the number of operations, or the number of objects, etc.

In an alternative, data processor 165 can be implemented as a computer that performs simulation. In that sense, the computer can operate a described above, not to the predict the failure of the machine as a whole, but to predict the failure of the tool (“no longer sharp” being the failure conditions). Setting up the simulator potentially requires only minimal interaction with human experts.

The above principle of detecting failures can be applied to machine parts as well. The tool will eventually fail. There are two consequences:
First, tool failure is a particular failure type (that can be predicted as such)
Second, tool failure can be simulated and used as input.

### Mode-Specific Training

FIG. 7 in combination with FIG. 8 illustrate that sub-ordinated modules can be trained for different modes separately.

Assuming to have 2 sub-ordinate modules (as in FIG. 2), the mode-classifier can differentiate historical data according to the modes so that the first module is trained with MODE_1 data and the second module is trained with MODE_2 data.

For current data, both modules would provide intermediate status indicators (such as 1{Y . . . } and 2{Y . . . }) and they would not receive a mode indication, cf. FIG. 2. Therefore, the first module would create “garbage”, every time the machine operates in MODE_2 (and vice versa for the second module). But since the operation mode classifier 333 provide the mode indicator (current data) 3{Y . . . }, the output network would (if trained) to disregard some intermediate data.

More in general, as the mode classifier module performs clustering, the number of clusters can be larger than two. It would be possible to dynamically add or remove sub-ordinated modules (that are not mode classifiers) depending on the number of mode clusters.

### Mode-Specific Bias

According to the topology of FIG. 2, the operation mode indicator 3{Y . . . } goes to output module 363. In implementations, the indicator can also serve as bias to sub-ordinated modules 313 and 323.

### Generic Computer

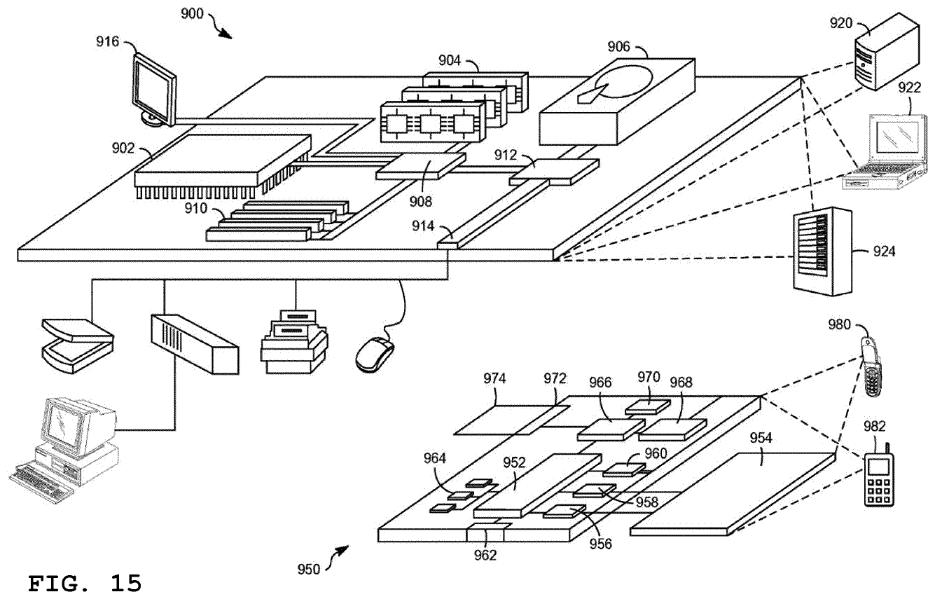

FIG. 15 illustrates an example of a generic computer device which may be used with the techniques described here. The figure is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, driving assistance systems or board computers of vehicles and other similar computing devices. For example, computing device 950 may be used as a frontend by a user (e.g., an operator of an industrial machine) to interact with the computing device 900. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method to predict failure of an industrial machine, the method using an arrangement of processing modules, the method comprising:
receiving machine data from the industrial machine by first, second and third sub-ordinated processing modules that are arranged to provide intermediate data to an output processing module, wherein the arrangement has been trained in advance by cascaded training,
by the first sub-ordinated processing module, processing the machine data to determine a first intermediate status indicator;
by the second sub-ordinated processing module, processing the machine data to determine a second intermediate status indicator;
by the third sub-ordinated processing module being an operation mode classifier module, processing the machine data to determine an operation mode indicator of the industrial machine; and
processing the first and second intermediate status indicators and the operation mode indicator by the output processing module, wherein the output processing module predicts failure of the industrial machine by providing prediction data.

2. The method according to claim 1, wherein a computer uses the arrangement that has been trained according to the following training sequence:
train the third sub-ordinated processing module with historical machine data;
run the trained third sub-ordinated processing module to obtain an historical mode indicator by processing historical machine data;
train the first and second sub-ordinated processing modules with historical machine data and with the historical mode indicator;
run the trained first and second sub-ordinated processing modules to obtain the first and second intermediate status indictors by processing historical machine data; and
train the output processing module by the historical mode indicator, by historical machine data and by historical failure data.

3. The method according to claim 1, wherein determining the operation mode indicator is performed by the operation mode classifier having been trained based on historical machine data that have been annotated by a human expert.

4. The method according to claim 3, wherein expert-annotated historical machine data are sensor data.

5. The method according to any of claim 1, wherein the operation mode classifier has been trained based on historical machine data so that during training, the operation mode classifier has clustered operation time of the machine into clusters of time-series segments.

6. The method according to claim 5, wherein the clusters of time-series segments are being assigned to operation modes indicators, selected from being assigned automatically or by interaction with a human expert.

7. The method according to claim 1, wherein the operation mode indicator is provided by the number of mode changes over time.

8. The method according to claim 1, wherein the status indicators are selected from current indicators that indicate the current status, and predictor indicators that indicate the status in the future.

9. The method according to claim 1, wherein the output processing module predicts failure of the industrial machine, selected from the following: time to failure, failure type, remaining useful life, failure interval.

10. The method according to claim 1, wherein the operation mode indicator further serves as a bias that is processed by both the first and the second sub-ordinated processing modules.

11. The method according to claim 1, wherein receiving machine data is performed by receiving a sub-set with sensor data and wherein determining the first and second intermediate status indicators is performed by the first and second sub-ordinated processing modules that process sub-sets with sensor data.

12. The method according to claim 1, wherein receiving machine data comprises receiving machine data through data harmonizers that—depending on contribution of machine data to the failure prediction—provide virtual machine data by a virtual sensor or filter incoming machine data.

13. The method according to claim 12, wherein receiving machine data through the data harmonizers comprises receiving machine data from harmonizers with processing modules that have been trained in advance by transfer learning.

14. The method according to claim 1, wherein receiving machine data comprises to receiving machine data that is at least partially enhanced by data resulting from simulation.

15. The method according to claim 1, further comprising forwarding the prediction data to a machine controller that controls the machine.

16. The method according to claim 15, wherein the machine controller lets the industrial machine assume a mode for wherein the time to fail is predicted to occur at the latest.

17. The method according to claim 15, wherein the machine controller lets the industrial machine assume a mode for which the time to maintain the machine occurs at the latest.

18. An industrial machine adapted to provide machine data to a computer that is adapted to perform a method according to claim 1 and that is further adapted to receive prediction data from the computer, wherein the industrial machine is associated with a machine controller that switches the operation mode of the industrial machine according to pre-defined optimization goals.

19. The industrial machine according to claim 18, wherein the pre-defined optimization goals are selected from the following: avoid maintenance as long as possible, operate in a mode for which failure is predicted to occur at the latest.

20. The industrial machine according to claim 18, selected from chemical reactors, metallurgical furnaces, vessels, pumps, motors, and engines.

21. A computer-implemented method for training a module arrangement having first, second and third sub-ordinated processing modules coupled to an output processing module to enable the module arrangement to provide a failure indicator with a failure prediction for an industrial machine, the method comprising the application of cascaded training with training the sub-ordinated processing modules, subsequently operating the trained sub-ordinated processing modules, and subsequently training the output processing module, wherein the cascaded training comprises:
train the third sub-ordinated processing module with historical machine data;
run the trained third sub-ordinated processing module to obtain an historical mode indicator by processing historical machine data;
train the first and second sub-ordinated processing modules with historical machine data and with the historical mode indicator;
run the trained first and second sub-ordinated processing modules to obtain the first and second intermediate status indictors by processing historical machine data {{X . . . }}N; and
train the output processing module by the historical mode indicator, by historical machine data and by historical failure data.

22. A computer program product that, when loaded into a memory of a computer system and executed by at least one processor of the computer system, causes the computer system to perform the steps of a computer-implemented method according to claim 1.

23. A computer system comprising a plurality of processing modules which, when executed by the computer system, perform the steps of the computer-implemented method according to claim 1.

24. An industrial machine comprising a computer that is adapted to process machine data by performing a method according to claim 1 and that is further adapted to provide prediction data, wherein the computer switches the operation mode of the industrial machine in response to the prediction data and according to pre-defined optimization goals, selected from the following: avoid maintenance as long as possible, operate in a mode for which failure is predicted to occur at the latest.
